(19) United States
(12) Patent Application Publication
(10) Pub. No.: US 2012/0079282 A1
(43) Pub. Date: Mar. 29, 2012

(54) SEAMLESS END-TO-END DATA OBFUSCATION AND ENCRYPTION

(75) Inventors: David Lowenstein, Mississauga (CA); Risu Na, Mississauga (CA)

(73) Assignee: Lionstone Capital Corporation, Mississauga (CA)

(21) Appl. No.: 13/170,649

(22) Filed: Jun. 28, 2011

Related U.S. Application Data
(60) Provisional application No. 61/358,983, filed on Jun. 28, 2010.

(51) Int. Cl. G06F 21/00

(52) U.S. Cl. 713/189

(57) ABSTRACT

A system comprises an input obfuscation module and an input encryption module coupled to the input obfuscation module. The input obfuscation and encryption modules are configured to define a first end of a secure channel for exchanging information with a secure software application module. The system further comprises an output de-obfuscation and decryption module coupled to the input obfuscation and encryption modules and is configured to define a second end of the secure channel, the secure channel having no seams between the first end of the secure channel and the second end of the secure channel. The system further comprises an output de-obfuscation module coupled to the output decryption module.

### CROSS-REFERENCE TO RELATED APPLICATIONS

This application claims priority to and the benefit of U.S. Provisional Patent Application No. 61/358,983, filed Jun. 28, 2010 and entitled “End-to-End Data Obfuscation and Encryption,” which is incorporated herein by reference in its entirety. This application is related to U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas,” which claims the benefit of U.S. Provisional Patent Application No. 61/358,980 filed Jun. 28, 2010, and entitled “Systems and Methods for Diversification of Encryption Algorithms and Obfuscation Symbols and/or Schemas,” both of which are incorporated herein by reference in their entireties.

### BACKGROUND

Embodiments described herein relate generally to data obfuscation and encryption, and more particularly to seamless, end-to-end input/output data obfuscation and encryption systems.

Processor-based computing devices, such as personal computers, typically receive input data from a user or other device, such as another processor-based computing device, via one or more input peripherals, such as a physical keyboard, a computer mouse or a touch-screen display. Such computing devices typically output at least a portion of the input data via a display device, such as a monitor or projector. For example, a user of a software application executing on a computing device can send information, such as a password, to the computing device by inputting alphanumeric information via a physical keyboard. In such a scenario, the keyboard sends signals indicating detected keypress events to a computing device processor for execution of system and/or software processes. The computing device can then display a visual representation of the struck keys, in the proper sequence, to a portion of a display rendered by an output monitor connected to the computing device.

Although this representation of the selected keys (and thus a user's password, in the above example) is often obfuscated on-screen using asterisk or other characters, the alphanumeric information conveyed by the user's keystrokes is discernible at multiple points along the path (or channel) from input to output. Indeed, this unsecure channel of data input and output is often a target of individuals who seek to obtain user passwords and other sensitive information, occasionally for nefarious purposes. Known tools used to obtain such information include but are not limited to hardware and software keystroke loggers (which obtain sensitive information by detecting and/or recording keystroke events), sniffers, memory dump tools, operating system hooks, code injection methods and rootkits (which obscure their own presence on an operating system and function through control of various operating system processes and utilities), and screen-capture programs (which take snapshots of display output to capture information).

Known security tools seek to combat such attacks by concealing sensitive information using various obfuscation and/or encryption methods. However, such tools are an incomplete deterrent to information thieves, inasmuch as they fail to eliminate “seams”—points along the input/output (I/O) and processing path at which information is unobfuscated and/or unencrypted and discernible by a malicious process or device. Thus, a need exists for systems and methods of I/O that include no such seams along the processing and/or data transfer path. A need further exists for an end-to-end solution that secures information from the initial point of user entry to the final point of output at a display device.

### SUMMARY

A system comprises an input obfuscation module and an input encryption module coupled to the input obfuscation module. The input obfuscation and encryption modules are configured to define a first end of a secure channel for exchanging information with a secure software application module. The system further comprises an output de-obfuscation and decryption module coupled to the input obfuscation and encryption modules and is configured to define a second end of the secure channel, the secure channel having no seams between the first end of the secure channel and the second end of the secure channel. The system further comprises an output de-obfuscation module coupled to the output decryption module.

### BRIEF DESCRIPTION OF THE DRAWINGS

FIG. 1 is a schematic illustration of a secure, seamless input/output system implemented on a computing device, according to an embodiment.

FIG. 2 is a flowchart that illustrates a method of obfuscating input data using a diversified scan code obfuscation mapping.

FIG. 3 is a schematic illustration of a context-aware, secure, seamless input/output system implemented on a computing device, according to an embodiment.

FIG. 4 is a schematic illustration of a secure software application configured to receive and send encrypted information, according to an embodiment.

FIG. 5 is a schematic illustration of a secure application agent that executes with an otherwise unsecure software application inside a computing environment and handles the transmission of data to and from the unsecure software application, according to an embodiment.

FIG. 6 is a schematic illustration of a computing device that includes a processor, a memory and input/output ports, according to an embodiment.

FIG. 7 is an illustration of a virtual keyboard rendered on a display device at a first screen position, according to an embodiment.

FIG. 8 is an illustration of a virtual keyboard rendered on a display device at a second screen position, according to an embodiment.

FIG. 9 is a block diagram illustrating the cryptographic feature structure of an obfuscator and encryptor module, according to an embodiment.

### DETAILED DESCRIPTION

In some embodiments of the invention disclosed herein, a secure input module, such as a physical or virtual keyboard, receives input datum or data such as alphanumeric input datum or data. In some embodiments, the secure input module can include a hardware- and/or software-based obfuscation and encryption module configured to convert the input data into an obfuscated and/or encrypted form. For example, in some embodiments, the obfuscation and encryption module can obfuscate the input data using a substitution or other cipher, or a shuffling procedure, such as a scan code shuffle. In some embodiments, the obfuscation and encryption module can further “super-obfuscate” the input data using a one-to-many substitution cipher, such as a homophonic substitution cipher. In some embodiments, the obfuscation and encryption module can additionally encrypt the input data using one or more known or proprietary encryption algorithms. In some embodiments, the obfuscation and encryption module can be diversified and can additionally obfuscate and/or encrypt the input data using a diversified known or proprietary algorithm or obfuscation module.

In some embodiments, the secure input module can be configured to bypass the obfuscation and encryption module and send the input data in unobfuscated, unencrypted form. In some embodiments, the obfuscation and encryption module can receive unsecured data from another computing device, such as a personal computer or smartphone. In such embodiments, the obfuscation and encryption module can receive the unsecured data over a wired or wireless connection, via, for example, a direct cable connection, a local area network (LAN), a wide area network (WAN), or the Internet.

In some embodiments, the secure input module can be connected to a computing device, such as a personal computer, smartphone, or other processor-based computing device. In some embodiments, the secure input module can send the input data to the computing device using standard input interface technologies and/or protocols. In such embodiments, the secure input module can thus define a first portion of a “secure channel”, inasmuch as obfuscated and/or encrypted data transmitted from the secure input module to the computing device cannot be discerned or interpreted by external hardware or software processes, such as keystroke loggers and the like.

In some embodiments, the computing device can include an input driver, such as a secure keyboard driver, configured to receive encrypted, obfuscated, encrypted and obfuscated, and/or unsecured input data and perform additional operations thereon. In some embodiments, the secure input driver can optionally obfuscate and/or encrypt unsecured input data. In some embodiments, the secure input driver can send received secured or unsecured input data to a secure software application and/or an unsecure software application, depending on whether the input data has been obfuscated and/or encrypted or left in its original, unsecured form. In some embodiments, the input driver can be a standard, unsecure system input driver that forwards the received secured and/or unsecured input data to an operating system process and/or a requesting software application. In such embodiments, input data sent in secured form within the computing device cannot be deciphered or understood by malware, rootkit, logger, or other processes.

In some embodiments, the secure software application can decrypt the received encrypted input data so as to perform conventional processes and/or calculations thereon or therewith. In some embodiments, the secure software application can de-obfuscate a second layer of “super obfuscation”, and perform the conventional processes and/or calculations on obfuscated (but not “super obfuscated”) input data. In such embodiments, the secure software application can define a second portion of the secure channel by re-super-obfuscating and/or re-encrypting the input data prior to transmission to any other operating system or system hardware or software module or process, such as a renderer module configured to send input or other data for rendering at an external display. In some embodiments, the unsecure software application can receive unsecured input data and perform operations and calculations thereon or therewith, and subsequently send the input data to the renderer device.

In some embodiments, a secure renderer device can receive secured and/or unsecured input data and prepare it for output to a display device such as a monitor. In some embodiments, the secure renderer device can be a hardware-based video or graphics card that includes or is operatively coupled to a de-obfuscator and/or decryptor module. In some embodiments, the de-obfuscator and/or decryptor module can de-obfuscate and/or decrypt secured input data, thereby converting it into a comprehensible form discernible by a viewer of the display device. In some embodiments the de-obfuscator and/or decryptor module can be a hardware component or device operatively or physically coupled to the secure renderer device. In some embodiments, the de-obfuscator and/or decryptor module can be a software-based module operatively coupled to the secure renderer device via a PCI bus or other channel.

In some embodiments, the secure renderer device can send the now-unencrypted and/or unobfuscated input data to a display device, such as a monitor, for display. Thus, in the above-described embodiments, the input data can travel from a first end point (user input) to a second end point (secure renderer device), entirely over a secure channel, such that at no point along the secure channel can the input data be discerned or comprehended by outside sources or individuals, thereby preserving security and data privacy.

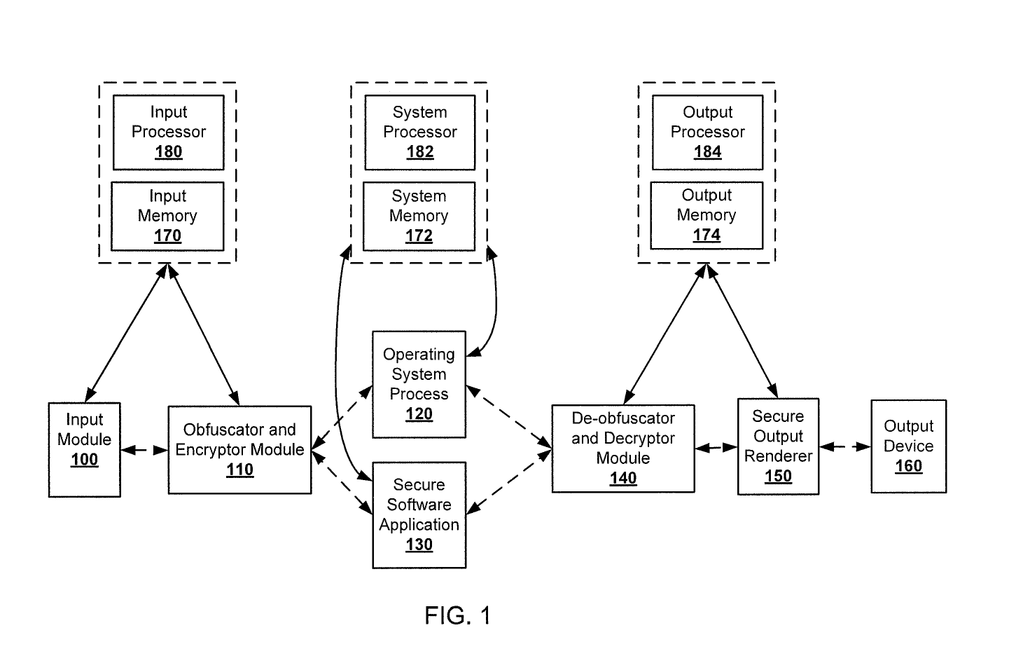

As used herein, the terms “secured channel” and “secure channel” mean a channel in which data is encrypted and/or obfuscated. In some embodiments, for example, a secured channel includes a cryptographic engine and/or an obfuscation module at a first end and a second end. In some embodiments, for example, a secured channel includes an obfuscator module, an encryptor module or and obfuscator and encryptor module at a first end and a de-obfuscator module, a decryptor module or a de-obfuscator and decryptor module at a second end. The obfuscator module, the encryptor module or the obfuscator and encryptor module can obfuscate data, encrypt data or obfuscate and encrypt data before sending the data via the secured channel. Similarly, the de-obfuscator module, the decryptor module or the de-obfuscator and decryptor module can de-obfuscate data, decrypt data or de-obfuscate and decrypt data received from the obfuscator module, the encryptor module or the obfuscator and encryptor module via the secured channel. In some embodiments, the secure channel can be further protected using hardware isolated memory (as shown in FIG. 1), virtually isolated memory (i.e., memory curtaining) and/or obfuscated memory space (e.g., by shuffling or moving data in memory).

FIG. 1 is a schematic illustration of a secure, seamless input/output system implemented on a computing device, according to an embodiment. More specifically, FIG. 1 illustrates an input module 100 operatively and/or physically coupled to an obfuscator and encryptor (hereinafter “O & E”) module 110 (also referred to as an obfuscator and encryptor agent). O & E module 110 and/or input module 100 is operatively coupled to an operating system process 120 and a secure software application 130 (also referred to as a secure software agent) stored in a memory (not shown in FIG. 1). Operating system process 120 and secure software application 130 are operatively coupled to a data decryptor and/or de-obfuscator (hereinafter “D & D”) module 140 (also referred to as a decryptor and de-obfuscator agent), which is operatively coupled to a secure output renderer 150 (also referred to as a secure renderer agent). Secure output renderer 150 is operatively coupled to an output device 160.

In some embodiments, O & E module 110 can be said to be a security module and/or an obfuscator-encryptor module. Similarly, in some embodiments, O & E module 110 can be said to include an obfuscator module (also referred to as an obfuscation module), an encryptor module (also referred to as an encryption module or a cryptographic engine), or both an obfuscator module and an encryption module. In some embodiments, D & D module 140 can be said to be a security module and/or a de-obfuscator-decryptor module. Similarly, in some embodiments, D & D module 140 can be said to include a de-obfuscator module (also referred to as a de-obfuscation module), an decryptor module (also referred to as a decryption module or a cryptographic engine), or both a de-obfuscator module and a decryption module.

Input module 100 can be any suitable hardware-based device and/or software-based interface configured to receive user input data. For example, input module 100 can be a physical keyboard, a virtual (on-screen) keyboard, a computer mouse, trackpad, trackpoint, joystick, controller, microphone (e.g., for capturing voice or other commands), optical camera, a touch-screen display configured to receive input gestures (e.g., a tap, swipe, or other input gesture), a biometric scanner (e.g., fingerprint scanner, retina scanner, etc.), a biometric sensor, a proximity card scanner, a barcode scanner and/or any other suitable input module. While described herein with respect to a keyboard, it should be understood that any suitable input module, as described above, can be used.

In some embodiments, input module 100 can be coupled to O & E module 110 by a physical cable (not shown in FIG. 1). In some embodiments, O & E module 110 can be physically disposed within input module 100. In some embodiments, input module 100 can be operatively coupled to O & E module 110 by a wireless protocol, such as Bluetooth, Wireless Universal Serial Bus (Wireless USB), Radio Frequency Identification (RFID), etc. In some embodiments, O & E module 110 can be a hardware-isolated software component. In some embodiments, the secure, seamless input/output system illustrated in FIG. 1 can include multiple input modules configured to receive input data in text, audio, graphic, or video form, used singularly, or in aggregate.

O & E module 110 can be a hardware-based module and/or software-based interface (stored or executed in memory and/or executed at a processor) configured to receive input data from input module 100 and obfuscate and/or encrypt the input data such that the input data's content or meaning is not discernible to outside sources, processes, or individuals. In some embodiments, O & E module 110 can obfuscate and/or encrypt the input data in a diversified manner, according to, for example, a diversified obfuscation and/or encryption algorithm diversified to an individual user and/or individual input module. In some embodiments, O & E module 110 can be a hardware-based module physically disposed within input module 100. In some embodiments, O & E module 110 can be a hardware-isolated software component. In such embodiments, the combination of input module 100 and O & E module 110 can be referred to as a “black box input obfuscator”, inasmuch as the two modules together receive input data and transform it into an uninterpretable form before transmitting the input data further—thereby allowing for no unauthorized detection of the plain-text input by another process, device or individual. In some embodiments, O & E module 110 can be, for example, a processor, an application-specific integrated circuit (ASIC), hardware-isolated software (stored or executed in memory and/or executed at a processor), or a field programmable gate array (FPGA) disposed within, for example, a physical keyboard or computer mouse. In some embodiments, O & E module 110 can be a custom hardware-based module configured to obfuscate and/or encrypt input data according to a custom and/or diversified algorithm. In such embodiments, for example, O & E module 110 can be a dedicated and/or custom processor configured to perform certain obfuscation and/or encryption functions without being capable of performing other functions.

In some embodiments, the O & E module 110 and/or the input module 100 can operate on, use and/or include input memory 170 configured to operate in conjunction with input processor 180 in obfuscating and/or encrypting input data. In such embodiments, for example, the input memory 170 can be a dedicated memory such that other applications and/or processes are denied access to the input memory 170. The input memory 170 can store the O & E module 110 itself as well as the data being manipulated by the O & E module 110. Similarly, in such embodiments, the input processor 180 can be a dedicated and/or custom processor configured to be used by the input module 100 and/or the O & E module 110 without being used by other modules, applications and/or processes. Such other modules, applications and/or processes can use another memory and/or processor (e.g., system memory 172 and/or system processor 182). As shown in FIG. 1, the input memory 170 can be protected using hardware-isolated memory. In such embodiments, the input memory 170 is physically isolated from the system memory 172 and the output memory 174. Thus, both the O & E module 110 itself as well as the data being manipulated by the O & E module 110 can be isolated from the system memory 172 and the output memory 174. In other embodiments, the input memory 170 can be protected using virtually isolated memory (i.e., memory curtaining) and/or obfuscated memory space (e.g., by shuffling or moving data in memory). In other embodiments, the O & E module 110 and/or the input module 100 can share input memory 170 and/or input processor 180 with secure software application 130, operating system process 120, D & D module 140, secure output renderer 150, output device 160 and/or other modules, applications and/or processes.

In some embodiments, O & E module 110 can be a hardware dongle device physically coupled to input module 100. In such embodiments, the hardware dongle device can transmit obfuscated and/or encrypted input data to operating system process 120 and/or software application 130 via a serial, USB, wireless or other known hardware device connection methods or protocols.

Operating system process 120 can be any standard operating system process, such as a process defined to execute on a Microsoft Windows, Linux, OS X, OS/2, Solaris, Apple iPhone OS, Google Android, Palm OS, or other operating system. Although only one operating process is shown in FIG. 1, it should be understood that in some embodiments, multiple operating system processes are possible. Secure software application 130 can be any valid software application designed to receive and decrypt encrypted and obfuscated data, process the obfuscated data to perform or provide the application's intended function, and re-encrypt and send the data to another module or device. In some embodiments, secure software application 130 can also de-obfuscate the data prior to processing the data and re-obfuscate the data prior to sending the data to another module or device. Accordingly, in some embodiments, the secure software application 130 can be said to be an agent including a cryptographic engine and/or an obfuscation module. In some embodiments, secure software application 130 can perform or provide the application's intended function without decrypting and/or de-obfuscating the data. In some embodiments, secure software application 130 can be a secure word processing, secure web browsing, or other secure software application. In some embodiments, secure software application 130 can be a secure version of a known software application generated by an automated application-securing process. In some embodiments, secure software application 130 can be a typical, unsecure version of a known software application that includes or executes a secure application agent (not shown in FIG. 1) capable of performing the receiving, de-obfuscation, decryption, processing, re-obfuscation, re-encryption, and sending described above. In other words, the secure application agent (such as secure software application 130) can be hosted or executed within other software modules, thereby providing a secure layer of encryption and/or obfuscation to those software modules by encrypting and/or obfuscating data sent from the software modules using a diversified (or unique) encryption or obfuscation algorithm.

As described above, the operating system process 120 and/or the secure software application 130 can operate on, use and/or include system memory 172 configured to operate in conjunction with system processor 182. In such embodiments, for example, the system memory 172 can be a dedicated memory such that other applications and/or processes are denied access to the memory. The system memory 172 can store the operating system process 120 and/or the secure software application 130 itself as well as the data being manipulated by the operating system process 120 and/or the secure software application 130. Similarly, in such embodiments, the system processor 182 can be a dedicated and/or custom processor configured to be used by the operating system process 120 and/or the secure software application 130 without being used by other modules, applications and/or processes. Such other modules, applications and/or processes can use another memory and/or processor (not shown in FIG. 1). As shown in FIG. 1, the system memory 172 can be protected using hardware-isolated memory. In such embodiments, the system memory 172 is physically isolated from the input memory 170 and the output memory 174. Thus, the operating system process 120 and/or the secure software application 130 itself as well as the data being manipulated by the operating system process 120 and/or the secure software application 130 can be isolated from the input memory 170 and the output memory 174. In other embodiments, the system memory 172 can be protected using virtually-isolated memory (i.e., memory curtaining) and/or obfuscated memory space (e.g., by shuffling or moving data in memory). In other embodiments, the operating system process 120 and/or the secure software application 130 can share system memory 172 and/or system processor 182 with O & E module 110, input module 100, D & D module 140, secure output renderer 150, output device 160 and/or other modules, applications and/or processes.

D & D module 140 can be a hardware-based module and/or software-based interface (stored or executed in memory and/or executed at a processor) configured to receive encrypted and/or obfuscated input data (i.e., “secured input data”) from operating system process 120 and/or software application 130. D & D module 140 can then de-obfuscate and/or decrypt the secured input data such that the now-unsecured input data can be rendered by secure output renderer 150 to an output device 160. In some embodiments, D & D module 140 can be a hardware-based module physically disposed within secure output renderer 150. For example, D & D module 140 can be a processor, an application-specific integrated circuit (ASIC), hardware-isolated software, or a field programmable gate array (FPGA) disposed within, for example, secure output renderer 150, where secure output renderer 150 is a hardware video card or other subcomponent of the computing device. In such embodiments, D & D module 140 can be configured to both decrypt and de-obfuscate secured input data and send the resulting unsecured data directly to secure output renderer 150 for subsequent output to output device 160. In some embodiments, D & D module 140 can be a dedicated and/or custom processor configured to perform certain de-obfuscation and/or decryption functions without being capable of performing other functions.

In some embodiments, the D & D module 140 and/or the secure output renderer 150 can operate on, use and/or include output memory 174 configured to operate in conjunction with output processor 184 in de-obfuscating and/or decrypting data. In such embodiments, for example, the output memory 174 can be a dedicated memory such that other applications and/or processes are denied access to the output memory 174. The output memory 174 can store the D & D module 140 itself as well as the data being manipulated by the D & D module 140. Similarly, in such embodiments, the output processor 184 can be a dedicated and/or custom processor configured to be used by the D & D module 140 and/or the secure output renderer 150 without being used by other modules, applications and/or processes. Such other modules, applications and/or processes can use another memory and/or processor (e.g., system memory 172 and/or system processor 182). As shown in FIG. 1, the output memory 174 can be protected using hardware-isolated memory. In such embodiments, the output memory 174 is physically isolated from the system memory 172 and the input memory 170. Thus, both the D & D module 140 itself as well as the data being manipulated by the D & D module 140 can be isolated from the system memory 172 and the input memory 170. In other embodiments, the output memory 174 can be protected using virtually isolated memory (i.e., memory curtaining) and/or obfuscated memory space (e.g., by shuffling or moving data in memory). In other embodiments, the D & D module 140 and/or the secure output renderer 150 can share output memory 174 and/or output processor 184 with secure software application 130, operating system process 120, O & E module 110, input module 100, output device 160 and/or other modules, applications and/or processes.

In some embodiments, D & D module 140 can be a software-based module and/or interface (stored or executed in memory and/or executed at a processor), such as a custom output driver configured to decrypt and/or de-obfuscate secured input data and send it to secure output renderer 150 via, for example, a PCI (Peripheral Component Interconnect) bus connection (not shown in FIG. 1). In some embodiments, D & D module 140 can be configured to decrypt encrypted input data and send the decrypted, but still obfuscated input data, to secure output renderer 150. In such embodiments, secure output renderer 150 can be a custom, hardware-based video and/or graphics card configured to de-obfuscate the received, obfuscated input data prior to transmission to output device 160.

Secure output renderer 150 can be any hardware- and/or software-based module (stored or executed in memory and/or executed at a processor) configured to render input data on an output device, such as output device 160. In some embodiments, secure output renderer 150 can be configured to perform decryption and/or de-obfuscation of input data. In some embodiments, secure output renderer 150 can receive decrypted and/or de-obfuscated input data from D & D module 140. In some embodiments, secure output renderer 150 can be a processor, an application-specific integrated circuit (ASIC), hardware-isolated software (stored or executed in memory and/or executed at a processor), or a field programmable gate array (FPGA). In some embodiments, secure output renderer 150 can be a dedicated video and/or graphics card, or an on-board video processor disposed within or physically coupled to a device motherboard and/or processor (not shown in FIG. 1).

Output device 160 can be any hardware device configured to display visual content for viewing by an observer. For example, output device 160 can be a monitor, such as a cathode-ray tube (CRT), liquid crystal display (LCD), light-emitting diode (LED) or other display. In other embodiments, the output device 160 can be an audio output device, such as, for example, a speaker.

In some embodiments, input module 100 can be configured to receive input data (not shown in FIG. 1), such as any combination of text, audio, video, graphic, image, or other data. In some embodiments, the input data can be entered into input module 100 by a user. In some embodiments, the input data can be received from another source, such as another processor-based device (not shown in FIG. 1).

Upon receipt of the input data, input module 100 can send the input data to O & E module 110. As noted above, in some embodiments, O & E module 110 can be a hardware device disposed within input module 100. In such embodiments, O & E module 110 can receive the input data via a circuit-based connection. As noted above, in some embodiments, O & E module 110 can be a hardware dongle device coupled to input module 100. In such embodiments, O & E module 110 can intercept signals sent by input module 100, including the received input data.

Upon receipt of the input data, O & E module 110 can be configured to transform the input data into an obfuscated and/or encrypted form, such as a diversified obfuscated and/or encrypted form. In some embodiments, O & E module 110 can first obfuscate the input data upon receipt from input module 100. For example, in some embodiments, O & E module 110 can obfuscate codes, such as hardware keyboard scan codes, or virtual keyboard ASCII codes, associated with the input data by using a substitution cipher or other obfuscation method, such as a scan code or ASCII shuffle cipher. In such embodiments, O & E module 110 can include a scan code or ASCII obfuscator module (not shown in FIG. 1) that replaces the standard scan code or ASCII value associated with each keypress entered by a user with an alternative (i.e., obfuscated) scan code or ASCII value. In some embodiments, the scan code obfuscator module can be a diversified scan code obfuscator module, unique to a particular hardware device and/or user. Such diversified modules, encryption and/or obfuscation algorithms are further described in connection with co-pending U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas”. In some embodiments, O & E module 110 can perform multiple rounds or layers of obfuscation on the input data. For example, in some embodiments O & E 110 can perform the scan code or ASCII shuffle cipher on the input data and subsequently further obfuscate the data using another substitution cipher method, such as a one-to-many, or homophonic substitution cipher. In some embodiments, input data that has undergone multiple layers of obfuscation by O & E module 110 can be referred to as “super-obfuscated” data.

Having obfuscated the input data, O & E module 110 can next encrypt the obfuscated input data using an encryption algorithm. For example, in some embodiments, O & E module 110 can implement a known encryption algorithm such as Advanced Encryption Standard (AES), Blowfish, RSA (Rivest, Shamir and Adleman), or another known encryption algorithm. Such known encryption algorithms can be standard and/or homogeneous encryption algorithms. In other embodiments, the encryption algorithm can be a custom, diversified and/or proprietary encryption algorithm or scheme, such as the encryption method described in connection with co-pending U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas”. In some embodiments, the encryption method or algorithm can be generated such that the encryption algorithm itself is diversified and/or customized to a given user or input module. In some embodiments, the encryption algorithm can be based on one or more of: a pseudo-random number generator, any mathematic operation that yields deterministic results, and/or any valid cryptographic operation.

Upon completion of the encryption process, O & E module 110 can send the obfuscated and encrypted input data to operating system process 120 and/or secure software application 130, thereby defining a first portion of a secure channel (i.e., a data path over which the contents of the input data cannot be discerned by other system processes or modules, software applications, hardware and/or software signal “sniffers”, malware, and the like). In some embodiments, O & E module 110 can send the encrypted and/or obfuscated input data via a wired hardware connection using known protocols for reception of input at a processor-based device (not shown in FIG. 1). For example, in some embodiments O & E module 110 can send the encrypted and/or obfuscated input data via a serial, USB, PS/2 or other known I/O protocol. In other embodiments, O & E module 110 can send the encrypted and/or obfuscated input data via a wireless connection using any suitable wireless protocol.

In some embodiments, the connection between O & E module 110 and operating system process 120 and/or secure software application 130 can be a direct connection. Similarly stated, in such embodiments, O & E module 110 can be operatively connected to operating system process 120 and/or secure software application 130 without any intervening modules or devices (e.g., using a direct cable, within a same physical device and/or using a direct wireless connection). In other embodiments, the connection between O & E module 110 and operating system process 120 and/or secure software application 130 is via a network. In such embodiments, O & E module 110 can be operatively connected to the operating system process 120 and/or the secure software application 130 via an intranet, a local area network (LAN), a wide area network (WAN), a wireless local area network (WLAN), the Internet and/or the like.

Although not shown in FIG. 1, the encrypted and/or obfuscated input data sent by O & E module 110 can typically be first received by standard hardware and software modules (stored or executed in memory and/or executed at a processor) designed to receive and send input data to operating system processes and software applications. For example, in some embodiments, the encrypted and/or obfuscated input data can be delivered to operating system process 120 and/or secure software application 130 via a sequence of: 1) hardware-based input ports; 2) system bus hardware; 3) software-based input drivers; and 4) a system memory 172 from which the operating system process 120 and/or secure software application 130 are being executed by system processor 182.

In some embodiments, O & E module 110 can send the encrypted and/or obfuscated input data to a custom input driver, such as a custom keyboard input driver (not shown in FIG. 1). In such embodiments, the custom keyboard input driver can be configured to perform additional operations on the encrypted and/or obfuscated input data, such as additional obfuscation and/or encryption processes, integrity checks, etc. In some embodiments, the custom keyboard input driver can intercept the encrypted and/or obfuscated input data sent from O & E module 110 such that the custom keyboard input driver has access to the encrypted and/or obfuscated input data before any other hardware- and/or software-based module associated with the computing device. In such embodiments, the custom keyboard input driver can forward the encrypted and/or obfuscated input data to operating system process 120 and/or secure software application 130 via the sequence of hardware and software modules described above.

As described above, in some embodiments, the input memory 170 used by the O & E module 110 and/or the input module 100 can be protected and/or secured by hardware-based software isolation. In other embodiments not including hardware-based software isolation, the input memory 170 can be protected and/or secured by virtually isolated memory space (also known as “memory curtaining”) and/or obfuscated memory space. In other embodiments, the O & E module 110 and/or the input module 100 can share system memory 172 with secure software application 130 and/or operating system process 120, and/or output memory 174 with D & D module 140 and secure output renderer 150. In some embodiments, one or more drivers associated with the O & E module 110 and/or the input module 100 can operate without the operating system process 120 monitoring the operation of the O & E module 110 and/or the input module 100 (i.e., without operating system awareness). In other embodiments, the operating system process 120 monitors the operation of the O & E module 110 and/or the input module 100.

In some embodiments, prior to sending the encrypted and/or obfuscated input data to operating system process 120 and/or secure software application 130, the O & E module 110 can identify a complementary agent in the secure software application 130 and/or the operating system process 120. After such a complementary agent is identified in the secure software application 130 and/or the operating system process 120, the O & E module 110 can send the encrypted and/or obfuscated input data to the secure software application 130 and/or the operating system process 120. This provides context awareness between the O & E module 110 and the secure software application 130 along with an additional level of security and/or data protection.

In some embodiments, the O & E module 110 can send the encrypted and/or obfuscated input data to multiple operating system processes and/or secure software applications over a wired and/or wireless network (e.g., a LAN, a WAN, a WLAN, the Internet, etc.). For example, the O & E module 110 can identify multiple operating system processes (e.g., similar to operating system process 120) and/or multiple secure software applications (e.g., similar to secure software application 130) to which the encrypted and/or obfuscated input data is to be sent. Specifically, the O & E module 110 can identify a complementary agent (e.g., a complementary operating system process 120 and/or secure software application 130) on multiple devices and/or nodes within the network. The O & E module 110 can then send the encrypted and/or obfuscated input data to each of the complementary agents.

Upon receipt of the encrypted and/or obfuscated input data from O & E module 110, operating system process 120 (executing in system processor 182) can transport the encrypted and/or obfuscated input data to and/or from various device and/or system resources, such as system processes, software-based modules and/or applications (stored or executed in memory and/or executed at a processor), system peripherals and/or hardware, etc (not shown in FIG. 1). Because encrypted and/or obfuscated input data is obfuscated and/or encrypted, however, in such embodiments neither operating system process 120 nor any observing device, process, or individual is capable of discerning the actual information represented by the encrypted and/or obfuscated input data string or strings. Thus, devices and/or software configured to “sniff” the transmission of information throughout memory as dictated by an operating system process, while capable of capturing the encrypted and/or obfuscated input data strings, will be incapable of using the strings in any useful way. For example, an installed “rootkit” process, hook, code injector or sniffer each is capable of surreptitiously monitoring operating system activity and may be able to capture the encrypted and/or obfuscated input data string(s) as they are transmitted within or by operating system process 120. Such rootkits or similar modules, however, will be incapable of delivering to a user the input data in its plain-text, unobfuscated, unencrypted form, inasmuch as the custom decryption and de-obfuscation techniques used to convert the encrypted and/or obfuscated input data into such form are located only within custom and/or diversified “black box” modules (such as O & E module 110, secured software application 130 and/or D & D module 140).

Upon receipt of encrypted and/or obfuscated input data from O & E module 110, secure software application 130 (e.g., executing in system processor 182) can first decrypt the encrypted and/or obfuscated input data, thereby converting it into an obfuscated-only (i.e., usable) form. In embodiments where the input data has undergone multiple obfuscation operations (and is thus “super-obfuscated”), secure software application 130 can perform a reverse or de-obfuscation process on the super-obfuscated data, leaving intact only the effects of the first layer of obfuscation on the input data. In some embodiments, secure software application 130 can then use the obfuscated input data to provide the particular functionality of that secure software application 430. For example, in some embodiments, secure software application 130 can perform one or more operations on the obfuscated input data, such as a text manipulation operation or other string operation, an arithmetic mathematical operation, etc. In some embodiments, secure software application 130 can use the obfuscated input data as part of any other operation and/or functionality of secure software application 130. In some embodiments, secure software application 130 can transfer the obfuscated input data to another system process or module (not shown in FIG. 1) for storage, display, etc. In such embodiments, secure software application 130 can first perform a second layer of obfuscation on the obfuscated input data and subsequently re-encrypt the then super-obfuscated input data, converting it back to secure form prior to transmission, such that the now-secured input data cannot be interpreted by unsecure processes or modules running on or coupled to the computing device. Thus, at all points during its path through a computing device, the input data is obfuscated, and at least at some points is obfuscated, super-obfuscated and/or encrypted.

In some embodiments, the operating system process 120 and/or secure software application 130 can receive encrypted and/or obfuscated input data from more than a single O & E module 110 over a wired and/or wireless network (e.g., a LAN, a WAN, a WLAN, the Internet, etc.). For example, multiple O & E modules can send encrypted and/or obfuscated input data to a common operating system process 120 and/or secure software application 130 for processing.

In some embodiments, operating system process 120 and/or secure software application 130 can be configured to send encrypted and/or obfuscated input data for eventual output at an output device, such as output device 160. The operating system process or secure software application (such as secure software application 130) thereby defines a second segment or portion of the “secure channel” mentioned above. In such embodiments, the operating system process 120 can send the encrypted and/or obfuscated input data discussed above to D & D module 140. As discussed above, in some embodiments, D & D module 140 can be physically or operatively coupled to output renderer 150. In such embodiments, D & D module 140 can decrypt and/or de-obfuscate the encrypted and/or obfuscated input data.

In some embodiments, prior to sending the encrypted and/or obfuscated input data to D & D module 140, the operating system process 120 and/or secure software application 130 can identify a complementary agent in the D & D module 140. After such a complementary agent is identified in the D & D module 140, the operating system process 120 and/or secure software application 130 can send the encrypted and/or obfuscated input data to the D & D module 140. This provides context awareness between the D & D module 140 and the secure software application 130 along with an additional level of security and/or data protection.

In some embodiments, the connection between D & D module 140 and operating system process 120 and/or secure software application 130 (executing in processor 182) can be a direct connection. Similarly stated, in such embodiments, D & D module 140 can be operatively connected to operating system process 120 and/or secure software application 130 without any intervening modules or devices (e.g., using a direct cable, within a same device and/or using a direct wireless connection). In other embodiments, the connection between D & D module 140 and operating system process 120 and/or secure software application 130 (executing in processor 182) is via a network. In such embodiments, D & D module 140 can be operatively connected to operating system process 120 and/or secure software application 130 via an intranet, a local area network (LAN), a wide area network (WAN), a wireless local area network (WLAN), the Internet and/or the like.

In some embodiments, the operating system process 120 and/or secure software application 130 can send the encrypted and/or obfuscated input data to more than a single device over a wired and/or wireless network (e.g., a LAN, a WAN, a WLAN, the Internet, etc.). For example, the operating system process 120 and/or secure software application 130 can identify multiple devices to which the encrypted and/or obfuscated input data is to be sent. Specifically, the operating system process 120 and/or secure software application 130 can identify a complementary agent (e.g., a complementary D & D module similar to D & D module 140) on multiple devices and/or nodes within the network. The operating system process 120 and/or secure software application 130 can then send the encrypted and/or obfuscated input data to each of the complementary agents.

In some embodiments, D & D module 140 can decrypt the encrypted and/or obfuscated input data by executing the appropriate decryption steps as dictated by the obfuscation and/or encryption algorithm used by O & E module 110 described above. In some embodiments, D & D module 140 can de-obfuscate the decrypted input data by “unshuffling” or decoding the obfuscated data. For example, in some embodiments, D & D module 140 can include a scan code or ASCII de-obfuscator module (not shown in FIG. 1) that replaces the obfuscated scan code or ASCII value for each scan code or ASCII value of the input data with the actual scan code value, thereby returning the input data into a simple obfuscated or fully de-obfuscated, interpretable form. In some embodiments, D & D module 140 can perform multiple de-obfuscation operations on the obfuscated or super-obfuscated data as necessary to return the input data into a fully or partially de-obfuscated, interpretable form.

After converting the input data into a plain-text or obfuscated form, in some embodiments, D & D module 140 can send the plain-text or obfuscated input data directly to secure output renderer 150. For example, in embodiments in which D & D module 140 is a hardware-based module disposed within or physically coupled to output renderer 150, and secure output renderer 150 is a hardware video card, D & D module 140 can send the plain-text or obfuscated PCI data directly to the video card for immediate rendering on or by output device 160. In such embodiments, if the input data is in obfuscated form when it reaches secure output renderer 150, secure output renderer 150 can de-obfuscate the input data prior to sending it to output device 160. In other embodiments, in which D & D module 140 is a software-based module (stored or executed in memory and/or executed at a processor), such as a software-based output driver, D & D module 140 can send the plain-text or obfuscated input data directly (i.e., bypassing the operating system) to output renderer 150 via the device's PCI bus for immediate rendering by or on the output device 160.

As described above, in some embodiments, the output memory 174 used by the D & D module 140 and/or the secure output renderer 150 can be protected and/or secured by hardware-based software isolation. In other embodiments not including hardware-based software isolation, the output memory 174 can be protected and/or secured by virtually isolated memory space (also known as “memory curtaining”) and/or obfuscated memory space. In other embodiments, the D & D module 140 and/or the secure output renderer 150 can share system memory 172 with secure software application 130 and/or operating system process 120, and/or input memory 170 with O & E module 110 and input module 100. In some embodiments, one or more drivers associated with the D & D module 140 and/or the secure output renderer 150 can operate without the operating system process 120 monitoring the operation of the D & D module 140 and/or the secure output renderer 150 (i.e., without operating system awareness). In other embodiments, the operating system process 120 monitors the operation of the D & D module 140 and/or the secure output renderer 150.

It should be noted that in each of the above-described embodiments, plain-text or obfuscated input data is available only to the secure (or “black box”) D & D module 140 and the secure output renderer 150. Thus, at no point along the secure channel between secure input module 100 and output renderer 150 is the plain-text input data discernible by any system, application, or other process, inasmuch as the input data is in obfuscated, encrypted form (i.e., “secured form”).

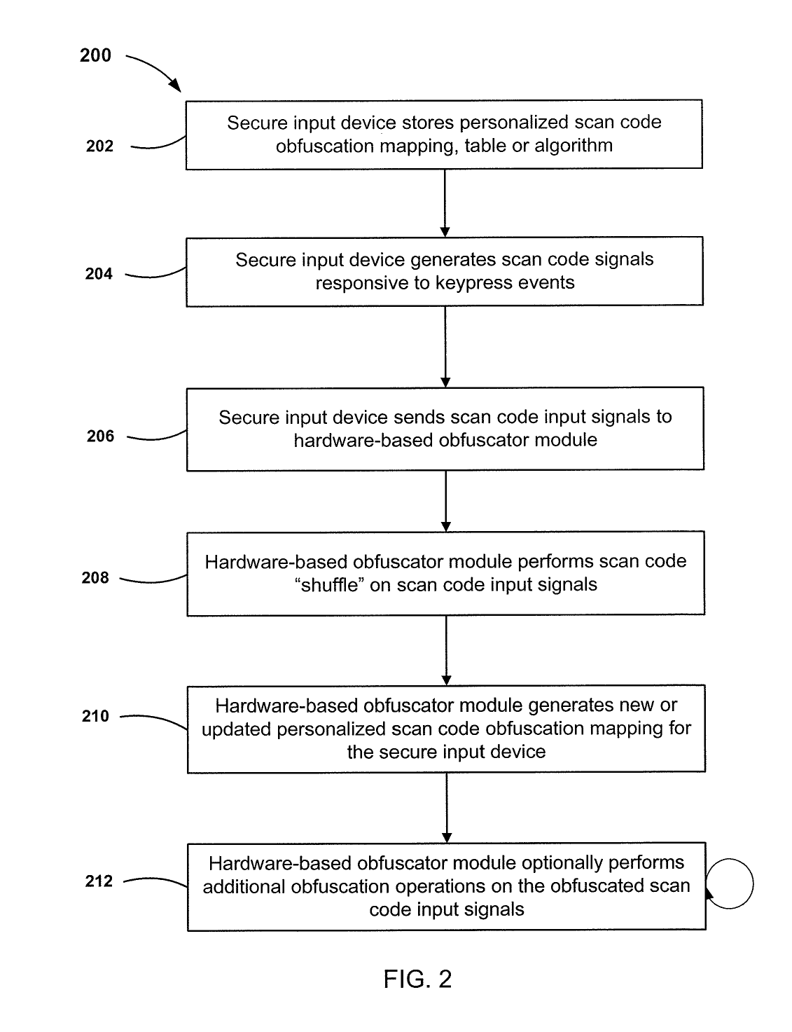

FIG. 2 is a flowchart that illustrates a method of obfuscating input data using a diversified scan code obfuscation mapping. As shown in FIG. 2, a secure or “black box” input device can be configured to store a diversified scan code obfuscation mapping or table, 202. The secure input device can be, for example, a physical keyboard that includes a hardware module that stores the diversified scan code obfuscation mapping in a memory (such as a RAM, a ROM, a hard disk drive, an optical drive, other removable media). In some embodiments, the secure input device can be configured to use the diversified scan code obfuscation mapping to obfuscate keyboard input via a hardware-based obfuscation module. In some embodiments, the hardware-based obfuscation module can store the diversified scan code obfuscation mapping, and can be, for example, an FPGA, ASIC, or other hardware component. In some embodiments, the secure input device can be a standard hardware input device that generates keypress scan codes and is connected to a hardware dongle. In such embodiments, the hardware dongle can include one or more hardware components that store a diversified scan code mapping and are configured to perform a diversified scan code mapping obfuscation on keypress input received from the secure input device.

In some embodiments, the hardware-based obfuscation module can generate a diversified scan code obfuscation mapping using a pseudo-random number generator, a mathematic operation that yields deterministic results, and/or a valid cryptographic operation. For example, in some embodiments, the hardware-based obfuscation module can generate the diversified scan code obfuscation mapping using a seed that is unique to that obfuscation module and/or particular secure input device. In such embodiments, the hardware-based obfuscation module can use the unique seed and/or a diversified mapping generation algorithm or operation, also unique to that particular secure input device and/or hardware-based obfuscation module, to generate the diversified scan code obfuscation mapping. In some embodiments, the diversified scan code obfuscation mapping can be “burned” into the hardware-based obfuscation module at the time of manufacture.

Such obfuscation and/or encryption algorithm personalization is described further in co-pending U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas”. In such embodiments, each alphanumeric symbol corresponding to a keypress scan code and/or found within the standard American Standard Code for Information Interchange (“ASCII”) character set can be represented by a different number of arbitrary size.

The secure input device can receive and/or generate one or more scan code signals in response to one or more keypresses, at 204. In some embodiments, the scan code signals can indicate the selection of various alphanumeric or other characters, symbols, or images associated with input keys disposed within the secure input device.

The secure input device can send the scan code signals to the hardware-based obfuscator module, at 206. In some embodiments, the hardware-based obfuscator module can receive the scan code signals one at a time or as a group, and accordingly perform obfuscation thereon in the same order. In some embodiments, the hardware-based obfuscator module can additionally perform encryption or other security operations on the received scan code signals.

The hardware-based obfuscator module can perform a scan code obfuscation or “shuffling” operation on the received scan code signals, at 208. In some embodiments, the hardware-based obfuscator module can, for each received scan code, reference the diversified scan code mapping entry corresponding to that scan code, determine thereby the appropriate obfuscated scan code value, and then assign the obfuscated scan code value to the received scan code signal, such that the standard scan code value for that scan code signal (or keypress) is replaced by the obfuscated scan code value.

The hardware-based obfuscator module can generate a new or updated diversified scan code obfuscation mapping for the secure input device, at 210. In some embodiments, the secure input device can be configured to automatically generate a new or updated diversified scan code obfuscation mapping at periodic intervals or in response to a user- or system-activated command received via, for example, a hardware switch connected to or disposed within the input device, or associated with a secure input renderer, such as the secure input renderer discussed in connection with FIG. 1 above

The hardware-based obfuscator module can optionally perform additional obfuscation operations on the obfuscated scan code input signals, 212. In some embodiments, the additional obfuscation operations can include, for example, a one-to-many, homophonic substitution cipher. In such embodiments, the homophonic substitution cipher can be configured to map a given obfuscated scan code to any one of multiple possible symbols or characters, thus balancing out the frequency of letter- or scan code-to-symbol matches in the substitution. It should be noted that this balancing out of symbol mapping frequency can provide an additional layer of protection or security to the obfuscated data, inasmuch as it thwarts statistically-based letter frequency analyses that purport to reverse engineer obfuscation schemes based on a known frequency of occurrence of letters in written language. In some embodiments, scan code signals that have undergone two or more obfuscation processes can be referred to as “super-obfuscated” scan codes or input data. Once the above obfuscation operation has been performed on a given string of scan code signals, an outside individual or process that converts or maps each obfuscated scan code value to a corresponding keystroke and/or alphanumeric character (such as an ASCII character) using a standard scan code/character mapping generates an indecipherable string of text and/or characters. Thus, the obfuscated scan code signals can be transmitted into, processed by, and output from a computing device without being discerned by third-party processes or observers, thus preserving data integrity, user privacy and overall security. In some embodiments, the hardware-based obfuscation module can further include an encryption module and/or encryption functionality configured to further secure the input data by performing one or more encryption operations on the data, such as Advanced Encryption Standard (AES), Data Encryption Standard (DES), Blowfish, or other known or proprietary encryption operation or standard.

In some embodiments, the obfuscated scan code signals can be returned to fully or partially de-obfuscated form by reversing the process described above. For example, each obfuscated scan code signal can be converted back into simple obfuscated or unobfuscated form by a hardware- and/or software-based de-obfuscator module configured to store, access, and/or use the diversified scan code obfuscation mapping to map each obfuscated scan code value back to the corresponding scan code. In embodiments where the scan codes have been obfuscated using multiple passes or multiple obfuscation algorithms, the scan code signals can be returned to simple obfuscated or de-obfuscated form only by reversing each obfuscation procedure in reverse order. Once the hardware- and/or software-based de-obfuscator module has converted each obfuscated scan code value back to the corresponding scan code, the corresponding alphanumeric character, symbol and/or ASCII characters can be discerned and/or interpreted, and are ready to be sent to, for example, an output device for display thereon. Using FIG. 1 as an example, the context awareness derives from the fact that the O & E module 110 identifies a complementary agent in the secure software application 130 for a given context and that secure software application 130 similarly identifies a complementary agent in D & D module 140.

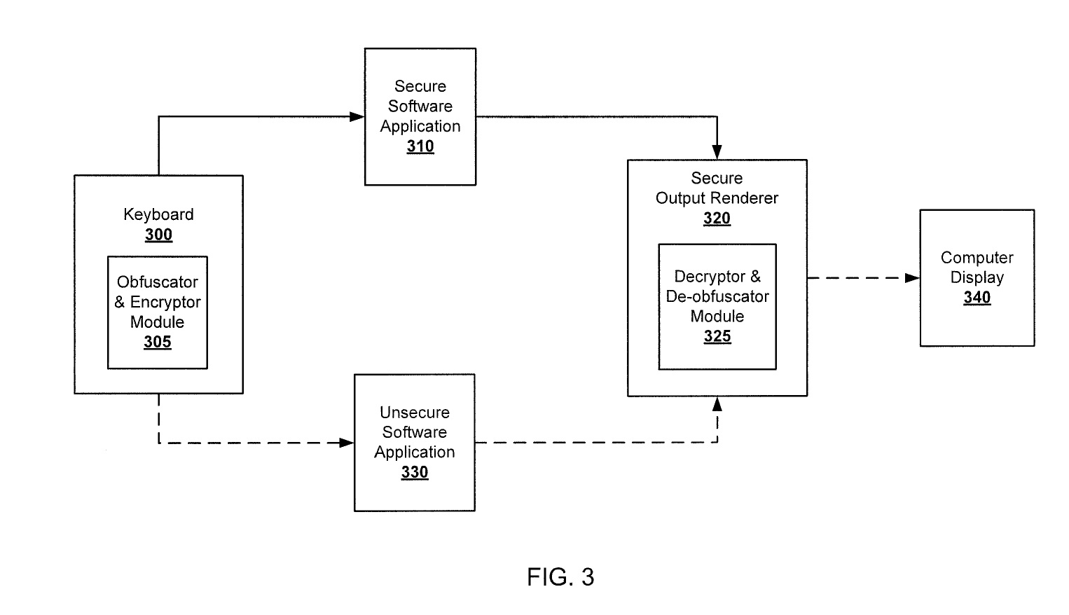

FIG. 3 is a schematic illustration of a context-aware, secure, seamless input/output system implemented on a personal computing device, according to an embodiment. More specifically, FIG. 3 illustrates a keyboard 300 that includes an obfuscator and encryptor (hereinafter “O & E”) module 305 and is operatively coupled to both a secure software application 310 and an unsecure software application 330. Secure software application 310 and unsecure software application 330 are operatively coupled to a secure output renderer 320 that includes a de-obfuscator and decryptor (hereinafter “D & D”) module 325. Secure output renderer 320 is operatively coupled to computer display 340.

Keyboard 300 can be any suitable hardware-based or virtual keyboard configured to receive input data from a user. For example, keyboard 300 can be a physical hardware keyboard such as a 101-key, 104-key, or other keyboard type that includes physical keys each associated and labeled with an alphanumeric character or text (for special function keys). In some embodiments, keyboard 300 can be a virtual keyboard, such as an on-screen keyboard. In such embodiments, the virtual keyboard can be defined by portions of an output display, such as computer display 340, that display a graphical representation of a traditional keyboard layout. In such embodiments, the virtual keyboard 300 can include virtual keys each defined by visual boundary lines rendered on the display and labeled with an associated alphanumeric character.

O & E module 305 can be any hardware- and/or software-based module (stored or executed in memory and/or executed at a processor) disposed or stored within a memory or other hardware module disposed within keyboard 300. In some embodiments, O & E module 305 can be a hardware dongle physically coupled to keyboard 300.

Secure software application 310 can be a software-based computer application (stored or executed in memory and/or executed at a processor) configured to receive and transmit input data, such as input data in obfuscated and/or encrypted form (i.e., “secured form”). In some embodiments, secure software application 310 can be configured to provide typical software functionality, such as word processing, web browsing, gaming, or other functionality. In some embodiments, secure software application 310 can be stored at a memory (not shown in FIG. 3) disposed within or operatively coupled to a processor (not shown in FIG. 3) of the computing device.

Secure output renderer 320 can be a hardware-based module configured to receive both secure and unsecured input data bound for an output device, such as computer display 340, and send signals configured to be visually displayed by the output device. In the illustrated embodiment, secure output renderer 320 includes D & D module 325.

D & D module 325 can be a hardware-based device configured to de-obfuscate and decrypt encrypted and/or obfuscated input data in preparation for rendering at an output device, such as computer display 340. In some embodiments, D & D module 325 can be a hardware-based module disposed within or physically coupled to a video and/or graphics card. In some embodiments, D & D module 325 can be a software-based module (stored or executed in memory and/or executed at a processor), such as a secure monitor driver operatively coupled to a video and/or graphics card via a bus, such as a PCI bus.

Unsecure software application 330 can be a software-based computer application (stored or executed in memory and/or executed at a processor) configured to receive and transmit input data in unobfuscated and/or unencrypted form (i.e., “unsecured form”), such as plain-text input data. In some embodiments, unsecure software application 330 can be configured to provide typical software functionality, such as word processing, web browsing, gaming, or other functionality. In some embodiments, unsecure software application 330 can be stored at a memory (not shown in FIG. 3) disposed within or operatively coupled to a processor (not shown in FIG. 3) of the computing device.

Computer display 340 can be any typical computer monitor or visual display device capable of rendering input data for viewing. In some embodiments, computer display 340 can be a CRT, LCD, or LED monitor. In some embodiments, computer display 340 can alternatively be a projector or other visual output device. In some embodiments, computer display 340 can be a touch-sensitive device, such as a touch-screen display.

Keyboard 300 can be configured to receive input data by detecting physical or virtual keypress events entered by a user and defining a signal that includes a code associated with each keypress. For example, in some embodiments, keyboard 300 can detect a keypress event and, based on the pressed or selected key, define a signal that includes a scan code or ASCII code associated with that key. Thus, upon detection of successive keypress events, keyboard 300 can define a string of scan codes or ASCII codes representative of the sequence of pressed keys. In embodiments where keyboard 300 is a physical keyboard device including physical keys, keyboard 300 can detect a keypress event by detecting the creation of a closed circuit associated with or coupled to one or more of the physical keys.

In embodiments where keyboard 300 is a virtual keyboard, keyboard 300 can detect a keypress when a user (not shown in FIG. 3) employs a computer mouse or other pointer-based input device to select a region of a display, such as computer display 340, associated with a virtual key. In embodiments where keyboard 300 is a virtual keyboard and computer display 340 is a touch-screen display, keyboard 300 can detect a keypress when a user touches a portion of the touch-screen display that defines a particular virtual key. In such embodiments, keyboard 300 can send ASCII codes in lieu of scan codes, and as such, use of the term “scan codes” below should be construed to mean “ASCII codes” when keyboard 300 is a virtual keyboard.

In some embodiments, keyboard 300 can be configured to send the string of scan codes to O & E module 305 for obfuscation and encryption when the scan codes are bound for a secure software application, such as secure software application 310. In such embodiments, keyboard 300 can alternatively send a string of unsecured scan codes to unsecure software application 330 without first sending the signals to O & E module 305. In such embodiments, keyboard 300 can be configured to receive a signal from an operating system process running on the computing device (not shown in FIG. 3), and/or a signal from secure software application 310 or unsecure software application 330, indicating the desired security level of the input data, i.e. whether the input data need be sent in obfuscated and encrypted or unsecured form.

In some embodiments, keyboard 300 can send the string of scan codes to O & E module 305. O & E module 305 can then obfuscate each scan code using a substitution cipher, such as a shuffling or mapping algorithm based on an alternative or diversified scan code mapping table or function as discussed in connection with FIG. 2 above. In some embodiments, O & E module 305 can subsequently perform additional obfuscation operations on the obfuscated scan codes, such as a one-to-many or homophonic substitution cipher obfuscation operation. In such embodiments, the obfuscated scan codes can be considered “super-obfuscated”. In some embodiments, O & E module 305 can next encrypt the obfuscated scan codes by using a standard, known, or proprietary encryption method or algorithm, such as Blowfish, AES, DES, and the like. Thus, in some embodiments, all scan codes transmitted from keyboard 300 via O & E module 305 can be in encrypted and/or obfuscated form, indecipherable by a user or other non-secure process.

In some embodiments, keyboard 300 can define a first portion of a secure channel (denoted by solid arrow lines in FIG. 3) by sending secured scan codes to secure software application 310. In some embodiments, keyboard 300 can send unsecured scan codes to unsecure software application 330. In such embodiments, keyboard 300 can send the secured and/or unsecured scan codes to the software applications via a hardware cable connection such as a serial, USB, PS/2 or other connection, and, subsequently, a software- and/or hardware-based keyboard input driver (not shown in FIG. 3). In some embodiments, the keyboard input driver can be a custom keyboard input driver that receives the encrypted and/or obfuscated and/or unsecured scan codes and sends them directly to secure software application 310 or unsecure software application 330 without first passing through any other operating system process or module. In some embodiments, the custom keyboard input driver can include logic that allows the custom keyboard input driver to determine whether to send received scan codes to secure software application 310 or unsecure software application 330. In some embodiments, the scan codes can be sent from the custom keyboard input driver to either or both of the software applications via an operating system process (not shown in FIG. 3).

Upon receipt of encrypted scan codes, secure software application 310 can decrypt the encrypted scan codes, thereby converting them into obfuscated form, usable and manipulable by secure software application 310. In embodiments where the secured scan codes are “super-obfuscated”, or have been run through multiple obfuscation operations, secure software application 310 can execute a de-obfuscation operation for each but the first obfuscation operation, rendering the scan codes in “simple” obfuscation form. In some embodiments secure software application 310 can decrypt the scan codes and use them in conjunction with any standard string or number operation within the application. In some embodiments, secure software application 310 can first convert the decrypted and/or de-obfuscated scan codes into alphanumeric text, using a keyboard-to-character mapping, such as a mapping based on the scan code or ASCII standard. In such embodiments, the converted scan or ASCII codes can be considered “input data”, and shall be referred to as such in connection with the remaining components of FIG. 3. In some embodiments, secure software application 310 can re-encrypt the input data before sending it to any other hardware-based module or software-based interface, peripheral, module, or process. When transmitting the input data for output at a display, such as computer display 340, secure software application 310 can define a second segment of the secure channel by re-encrypting the input data prior to sending it to secure output renderer 320.

Upon receipt of unsecure (i.e., plain text) input data, unsecure software application 330 can perform any standard string or number operation on the input data. In some embodiments, unsecure software application 310 can send the input data to secure system output renderer 320 for rendering at a display device such as computer display 340.

When it receives secured input data from secure software application 310, secure output renderer 320 can be configured to decrypt and de-obfuscate the encrypted and/or obfuscated input data using D & D module 325, thereby converting the input data into unencrypted or simple obfuscated-only form. In some embodiments, secure output renderer 320 can send these newly-manipulable input data, and/or other input data received from unsecure software application 330, directly to computer display 340 for display.

In some embodiments, keyboard O & E module 305 can be a software- and/or hardware-based module disposed within the computing device or operating at a processor (not shown in FIG. 3) of the computing device, as opposed to within a physical keyboard. In such embodiments, virtual keyboard 300 can be a software module (stored or executed in memory and/or executed at a processor), interface or construct defined by O & E module 305 and/or secure software application 310. In some embodiments, O & E module 305 can be operatively coupled to and/or included in secure software application 310, which is operatively coupled to secure output renderer 320.

In some embodiments using a virtual keyboard 300, the mouse position input use O & E module 305. Similarly stated, the mouse position input on a virtual keyboard 300 can be encrypted and/or obfuscated by O & E module 305. In other embodiments, a touch screen can be used as an input device. In such embodiments, the touch position input on the touch screen can use O & E module 305. Similarly stated, the touch position input on the touch screen can be encrypted and/or obfuscated by O & E module 305.

In some embodiments, O & E module 305 can be configured to define the virtual keyboard 300 and receive virtual keyboard input data by a keyboard floating method. In such embodiments, O & E module 305 can be configured to both send signals to and receive signals from computer display 340 via secure software application 310 and secure output renderer 320. In some embodiments, the signals can cause the rendered virtual keyboard 300 to appear to “float”, or move randomly, within a fixed region of the monitor display. In such embodiments, O & E module 305 can send a signal to “move” the virtual keyboard display in response to a key selection made by a user (not shown in FIG. 3), such that the virtual keyboard “floats” within a fixed region of the display as input data is entered by the user.

In some embodiments, O & E module 305 can receive signals including display coordinates that indicate, for example, the time and display location of a user mouse-click (and thus a user's virtual key selection). In such embodiments, O & E module 305 can be configured to match the received display coordinates with a key-location mapping that indicates the display coordinates for the virtual keyboard and/or each virtual key (not shown in FIG. 3) to determine which virtual key (and thus, alphanumeric value) was associated with the received display coordinates at the time of the mouse-click. O & E module 305 can then employ the received coordinates and/or the received time, and the key-location mapping to determine which virtual key was selected by the user. By performing the above steps on a sequence of received display coordinate and/or time pairs, O & E module 305 can determine a sequence of virtual key selections, and thus user input.

It should be noted that because only O & E module 305 has access to the key-location mapping described above, all other processes and modules are incapable of deciphering, based on the display coordinates and/or times, the actual virtual key selections. In other words, in embodiments including a virtual keyboard 300 such as those described above, a malicious software process or program that detects mouse-click or other pointer selection coordinates will be incapable of determining which virtual keys are being selected by the user, inasmuch as the changing coordinates of each key obfuscates the selected keys' respective display coordinates (i.e., screen locations) at any given time. Thus, in such embodiments, the input data is obfuscated in that the coordinates defining a given ASCII character are configured to shift with one or more selections of a virtual key (or “virtual keypress”).

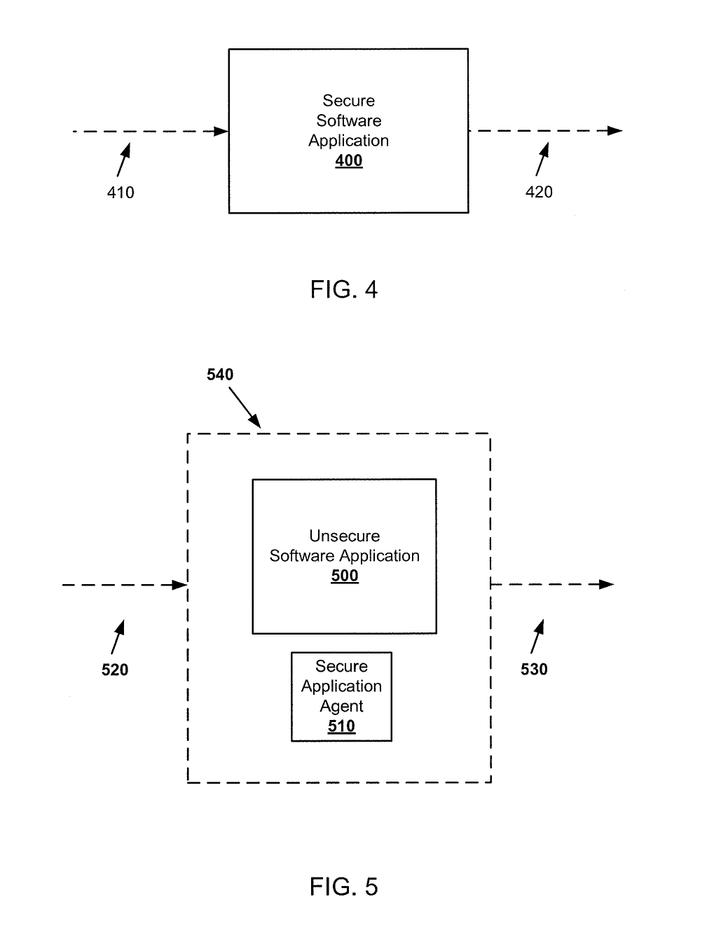

FIG. 4 is a schematic illustration of a secure software application (stored or executed in memory and/or executed at a processor) configured to receive and send encrypted information, according to an embodiment. More specifically, FIG. 4 illustrates a secure software application 400 that receives secured information 410 and sends secured information 420. In some embodiments, secure software application 400 can be a secure version of a software-based application, such as a word-processing, web browsing, or other software application. For example, in some embodiments, secure software application 400 can be an instance of a known software application that has been configured to exchange input data in a secure fashion within the systems described above. Thus, in some embodiments, secure software application 400 can be, for example, a secure version of an application such as the Microsoft Word word-processing application or the Mozilla Firefox web browser.

In some embodiments, secure software application 400 can be configured to receive encrypted and/or obfuscated input data 410 from, for example, another secure software application, an operating system process, a secure or standard system input driver, or other process, module, or device. In some embodiments, secure software application 400 can then decrypt and/or de-obfuscate the encrypted and/or obfuscated input data as necessary so as to convert it into a usable form, such as a plain-text or simple obfuscated-only form. In some embodiments, secure software application 400 can perform multiple de-obfuscation operations on input data that has been run through multiple obfuscation operations as necessary to render in usable form. In some embodiments, having converted the encrypted and/or obfuscated input data into an usable form, such as a simple obfuscated form, secure software application 400 can then perform one or more operations on or with the obfuscated input data. For example, in some embodiments, secure software application 400 can manipulate text represented by the obfuscated input data, and/or perform a mathematical calculation based on numerical information included in the obfuscated input data. During this processing, or upon completion of the processing, secure software application 400 can perform one or more additional obfuscation operations as necessary to “super-obfuscate” the data, and then re-encrypt it so as to convert it back into secure form. Thus, when secure software application 400 sends the secured input data 420 to, for example, another secure process or device, it does so over a secure channel, in which the encrypted and/or obfuscated input data cannot be readily observed or comprehended by an individual or computing process or device.

FIG. 5 is a schematic illustration of a secure application agent that executes with an otherwise unsecure software application (stored or executed in memory and/or executed at a processor) inside a computing environment and handles the transmission of data to and from the unsecure software application, according to an embodiment. More specifically, FIG. 5 illustrates a secure application agent 510 that executes with unsecure software application 500 inside computing environment 540, receives encrypted and/or obfuscated data 520 and sends encrypted and/or obfuscated data 530. In some embodiments, unsecure software application 500 can be any typical software-based application, such as a word-processing, web browsing, or other software application. For example, in some embodiments, unsecure software application 500 can be an instance of a known software application, such as an instance of the Microsoft Word word-processing application or an instance of the Mozilla Firefox web browser. In some embodiments, computing environment 540 can be any known computing environment, such as an operating system running on a computing device such as a personal computer, server computer, mobile device, etc.

In some embodiments, secure application agent 510 can be configured to handle all exchanges of data between unsecure software application 500 and all other software- and/or hardware-based modules and/or resources. Thus, in some embodiments, when unsecure software application 500 receives encrypted and/or obfuscated input data 520 from another module or resource, secure application agent 510 can decrypt and/or de-obfuscate encrypted and/or obfuscated input data 520, thereby converting it into a form usable by unsecure software application 500 and secure application agent 510. In some embodiments, secure application agent 510 can perform multiple de-obfuscation operations as necessary to convert obfuscated input data 520 into usable form. In this manner, secure application agent 510 effectively converts unsecure software application 500 into a more secure software application.

In some embodiments, after having decrypted and/or de-obfuscated encrypted and/or obfuscated input data 520, secure application agent 510 can send the now-usable input data to unsecure software application 500, allowing unsecure software application 500 to then perform one or more operations on or with the plain-text and/or obfuscated input data. For example, in some embodiments, unsecure software application 500 can manipulate text represented by the obfuscated and/or plain-text input data, and/or perform a mathematical calculation based on numerical information included in the obfuscated and/or plain-text input data. During this processing, or upon completion of the processing, unsecure software application 500 can send the plain-text or de-obfuscated input data to secure application agent 510, which can then further obfuscate and/or re-encrypt the obfuscated and/or plain-text input data, thereby generating encrypted and/or obfuscated input data 530. Thus, when secure application agent 510 sends encrypted and/or obfuscated input data 530 to, for example, another secure process or device, it does so over a secure channel—in which the encrypted and/or obfuscated input data cannot be readily observed or comprehended by an individual or computing process or device. In some embodiments, secure application agent 510 can send the encrypted and/or obfuscated input data 530 to another secure module, such as a secure hardware, software and/or hardware-isolated software module executing on or as part of the same operating system process or thread as unsecure software application 500, another operating system process or program, or another device containing or comprising a secure hardware, software and/or hardware-isolated software module (stored or executed in memory and/or executed at a processor), such as a mobile device, personal computer, server computer, etc. In some embodiments, secure application agent 510 can send the encrypted and/or obfuscated input data 530 to a secure driver, such as a monitor or video output driver, for further processing and/or output.

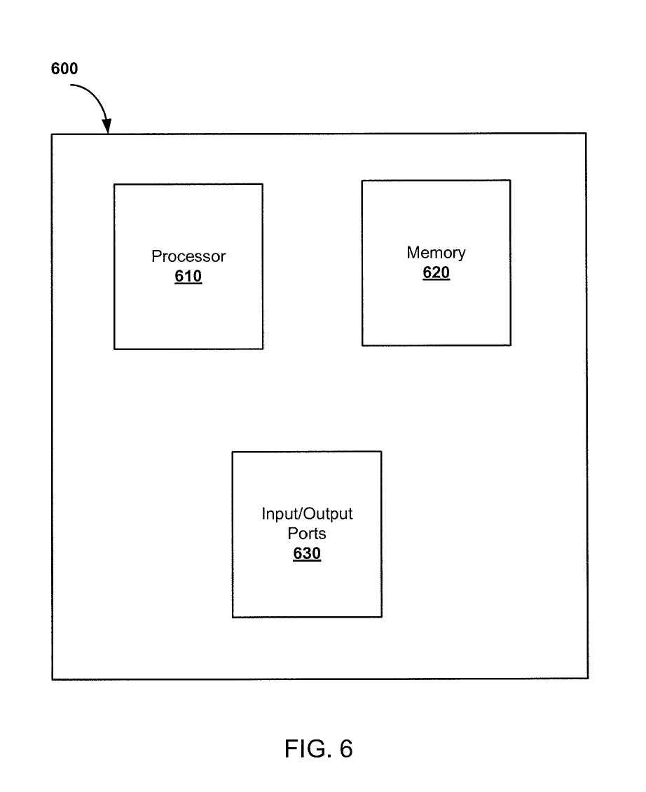

FIG. 6 is a schematic illustration of a computing device that includes a processor, a memory and input/output ports, according to an embodiment. More specifically, FIG. 6 illustrates a computing device 600 that includes a processor 610 operatively coupled to a memory 620 and input/output ports 630. In some embodiments, processor 610, memory 620, and the input/output ports 630 can be connected by, for example, a bus or one or more integrated circuits (not shown in FIG. 6).

Computing device 600 can be any known computing device, such as a personal desktop computer, a personal notebook or laptop computer, a netbook, a tablet device, a smartphone, a smart storage device or other computing device.

Processor 610 can be, for example, a computing or processing device that is dedicated to performing one or more specific tasks. For example, processor 610 can be a commercially available microprocessor, an application-specific integrated circuit (ASIC) or a combination of ASICs, which are designed to achieve one or more specific functions, or enable one or more specific devices or applications. In yet another embodiment, the processor 610 can be an FPGA, an analog or digital circuit, or a combination of multiple circuits. Processor 610 can also include a variety of other components, such as for example, co-processors, graphic processors, etc., depending upon the desired functionality of the code.

Memory 620 can be any type of memory such as, for example, a read-only memory (ROM) or a random-access memory (RAM). In some embodiments, memory 620 could be, for example, any type of computer-readable media, such as a hard-disk drive, a compact disc read-only memory (CD-ROM), a digital video disc (DVD), a Blu-ray disc, a flash memory card, or other portable digital memory type. Memory 620 can also include other types of memory that are suitable for storing data in a form retrievable by processor 620. For example, electronically programmable read only memory (EPROM), erasable electronically programmable read only memory (EEPROM), flash memory, as well as other suitable forms of memory can be included within memory 620. Memory 620 can be configured to send signals to and receive signals from processor 610 and input/output ports 630.

Input/output ports 630 can be any known combination of hardware and/or software (stored or executed in memory and/or executed at a processor) configured to facilitate the transfer of data to and/or from processor 610 via memory 620. In some embodiments, input/output ports 630 can include one or more of: an input device driver, an output device driver, and/or a physical peripheral I/O connection such as a serial, USB, or other connection.

In some embodiments, computing device 600 can be configured to receive input data (not shown in FIG. 6) from an input peripheral (also not shown in FIG. 6) via an input port from input/output ports 630. In some embodiments, the received input data can be stored in memory 620 and/or processed by processor 610. In some embodiments, computing device 600 can be configured to output the received input data via an output port from input/output ports 630.

In some embodiments, computing device 600 can be configured to implement any of the above-described embodiments, such as embodiments described in connection with FIGS. 1, 2, 3 4 and 5 above. Thus, computing device 600 can be configured to store in memory 620 any code or other instructions necessary to execute the above-described embodiments, such as a valid operating system, secure software application, secure output renderer, etc. (not shown in FIG. 6), such as those discussed in connection with the embodiments described above. Such instructions and/or code can be executed at processor 610. In some embodiments, computing device 600 can be configured to operatively connect and/or couple to any additional hardware components and/or devices necessary to implement the above-described methods and embodiments, such as an input device, a display device, an obfuscator an obfuscator and/or encryptor dongle, etc. (not shown in FIG. 6).

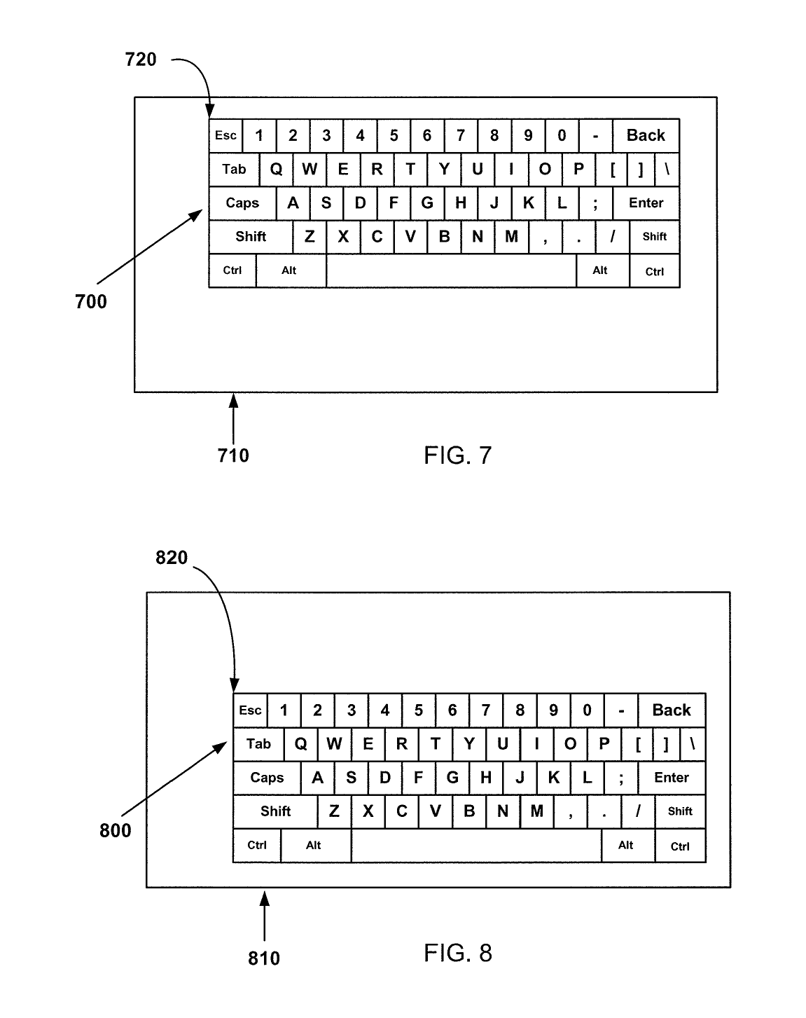

FIG. 7 is an illustration of a virtual keyboard rendered on a display device at a first screen position, according to an embodiment. More specifically, FIG. 7 illustrates a virtual keyboard 700 rendered within a display portion 710 at a first screen position 720, according to an embodiment.

Virtual keyboard 700 can be any suitable arrangement of screen elements configured to receive user input via a user input device (not shown in FIG. 7), such as a computer mouse, joystick, touchpad, touch-screen, etc. In some embodiments, virtual keyboard 700 can include one or more typical virtual keys, such as virtual keys corresponding to traditional physical keys of a physical keyboard. In some embodiments, the virtual keys can be arranged according to a traditional QWERTY, Dvorak, or other key layout.

Display portion 710 can be any portion of a screen display with dimensions sufficient to include virtual keyboard 700. For example, in some embodiments, display portion 710 can be a rectangle, square, or other shape rendered on a screen within which virtual keyboard 700 is also rendered. In some embodiments, virtual keyboard 700 can be rendered at a specific, predetermined, or random screen position or coordinates, such as first screen position 720.

In some embodiments, a computing device (not shown in FIG. 7) can render virtual keyboard 700 on a display device, such as a computer monitor. In such embodiments, the computing device can also render display portion 710 on the display device. As described in connection with FIG. 3 above, the computing device can be configured to “move” a virtual keyboard, such as virtual keyboard 700, to a different position within a fixed region of the display, such as display portion 710, in response to virtual keypress events received from a user. In this manner, as a user inputs information using virtual keyboard 700, its screen position—and thus the screen positions of all virtual keys included therein—varies within display portion 710. Thus, when the screen coordinates of a given virtual key are sent in response to a virtual keypress, keylogging, screen capture and other input detection devices and/or processes (such as a module configured to track mouse-click coordinates) will be incapable of mapping the screen coordinates of a given mouse-click with a particular virtual key selection—thereby obfuscating the virtual keyboard input data.

FIG. 8 is an illustration of a virtual keyboard rendered on a display device at a second screen position, according to an embodiment. More specifically, FIG. 8 illustrates a virtual keyboard 800 rendered within a display portion 810 at a second screen position 820, according to an embodiment.

Virtual keyboard 800 can be any suitable arrangement of screen elements configured to receive user input via a user input device (not shown in FIG. 8), such as a computer mouse, joystick, touchpad, touch-screen, etc. In some embodiments, virtual keyboard 800 can include one or more typical virtual keys, such as virtual keys corresponding to traditional physical keys of a physical keyboard. In some embodiments, the virtual keys can be arranged according to a traditional QWERTY, Dvorak, or other key layout.

Display portion 810 can be any portion of a screen display with dimensions sufficient to include virtual keyboard 800. For example, in some embodiments, display portion 810 can be a rectangle, square, or other shape rendered on a screen within which virtual keyboard 800 is also rendered. In some embodiments, virtual keyboard 800 can be rendered at a specific, predetermined, or random screen position or coordinates, such as second screen position 820.

In some embodiments, a computing device (not shown in FIG. 8) can render virtual keyboard 800 on a display device, such as a computer monitor. In such embodiments, the computing device can also render display portion 810 on the display device. As described in connection with FIG. 3 above, the computing device can be configured to “move” a virtual keyboard, such as virtual keyboard 800, to a different position within a fixed region of the display, such as display portion 810, in response to virtual keypress events received from a user. In this manner, as a user inputs information using virtual keyboard 800, its screen position—and thus the screen positions of all virtual keys included therein—varies within display portion 810. Thus, when the screen coordinates of a given virtual key are sent in response to a virtual keypress, screen-capture and other input detection devices and/or processes (such as a module configured to track mouse-click coordinates) will be incapable of mapping the screen coordinates of a given mouse-click with a particular virtual key selection—thereby obfuscating the virtual keyboard input data.

In some embodiments using a virtual keyboard 800, the mouse position input uses an O & E module (e.g., O & E module 110 shown in FIG. 1). Similarly stated, the mouse position input on a virtual keyboard 800 can be encrypted and/or obfuscated by an E & O module. In other embodiments, a touch screen can be used as an input device. In such embodiments, the touch position input on the touch screen can use an O & E module. Similarly stated, the touch position input on the touch screen can be encrypted and/or obfuscated by an O & E module 305.

While shown in FIGS. 7 and 8 as a virtual keyboard, in other embodiments, any other suitable input prompt can be displayed on a screen display. For example, one or more icons on a touch-screen display can be displayed. Similar to the virtual keyboards 700 and 800, each time a user provides a input gesture (e.g., a tap, swipe, or other input gesture) on the touch-screen display, the icons can be presented in different positions and/or with a different orientation within a fixed region of the touch-screen display. Thus, when the touch-screen coordinates of an input gesture are sent in response to the input gesture, screen capture and other input detection devices and/or processes (such as a module configured to track mouse-click coordinates) will be incapable of mapping the touch-screen coordinates of a given input gesture with a particular icon selection and/or other action—thereby obfuscating the input data.

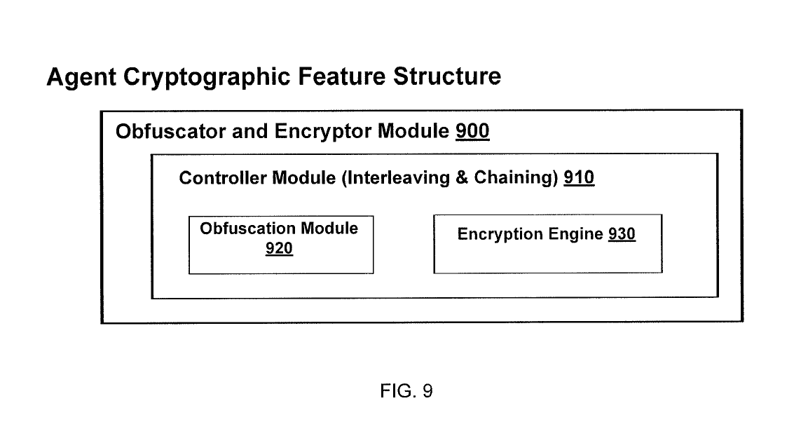

FIG. 9 is a block diagram illustrating the cryptographic feature structure of an obfuscator and encryptor (O & E) module 900, according to an embodiment. While shown in FIG. 9 as an O & E module 900, in some embodiments, de-obfuscator and decryptor modules can be structured similar to O & E module 900. O & E module 900 can be structurally and functionally similar to O & E module 110, shown and described above with respect to FIG. 1. The O & E module includes at least one obfuscation module 920 and at least one encryption engine 930. The obfuscation module 920 is configured to obfuscate data received from, for example, an input device and/or a process. Similarly, the encryption engine 930 is configured to encrypt data received from, for example, an input device and/or a process. The obfuscation 920 and/or encryption module 930 can include multiple sub-modules and/or engines that enable and/or perform different steps and/or routines associated with the obfuscation and/or encryption process. Such sub-modules and/or engines are described in detail in U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas,” which is incorporated herein by reference in its entirety.

The O & E module 410 also includes a controller module 910, which controls and/or coordinates obfuscation module 920 and encryption engine 930. Specifically, the controller module 910 can control and/or coordinate the rounds of encryption and/or obfuscation. Thus, the controller module 910 can determine a sequence of obfuscation and/or encryption algorithms to apply to input data. Similarly stated, the controller module 910 can interleave encryption processes with obfuscation processes and can chain multiple encryption processes and/or obfuscation processes together. Thus, input data can be processed using multiple rounds of encryption and/or obfuscation interleaved and/or chained together as described in detail in U.S. patent application bearing Attorney Docket No. FNTE-002/01US 313768-2003, filed on same date, and entitled “Systems and Methods for Diversification of Encryption Algorithms and Obfuscation Symbols, Symbol Spaces and/or Schemas,” which is incorporated herein by reference in its entirety.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

For example, while shown and described above as receiving input from a user input (e.g., a keyboard) and outputting the data to a user output device (e.g., a display), in other embodiments the systems and methods described herein can receive input data from a process (e.g., a system process, an application process, a machine-to-machine process, etc.), a machine, a module, and/or a software component (stored or executed in memory and/or executed at a processor) and the output can be to another process (e.g., a system process, an application process, a machine-to-machine process, etc.), machine, module and/or software component. In some embodiments, such processes, machines, modules, and/or software components can be unrelated to user input and/or output to a user. Referring to FIG. 1, for example, the O & E module 110 can receive input data from a process and D & D module 140 can output the data to another process. Thus, the secure channel between the O & E module 110 and the D & D module 140 can be used to secure convey data between two processes.

While shown and described above as a single process using a single O & E module and/or a single D & D module, in some embodiments, multiple processes can use a common O & E module and/or a common D & D module. For example, multiple processes (e.g., system processes, application processes, a machine-to-machine process, etc.), machines, modules, software components and/or user input devices can use a common O & E module. For another example, multiple processes (e.g., system processes, application processes, a machine-to-machine process, etc.), machines, modules, software components and/or output devices can use a common D & D module. In other embodiments, multiple processes (e.g., system processes, application processes, a machine-to-machine process, etc.), machines, modules, software components and/or output devices can use different O & E modules and/or D & D modules.

While shown and described above as using a common encryption and/or obfuscation algorithm between an O & E module, a secure software application and a D & D module, in some embodiments, the encryption and/or obfuscation algorithm between the O & E module and the secure software application can be different than the encryption and/or obfuscation algorithm between the secure software application and the D & D module. For example, an encryption key used between the O & E module and the secure software application can be different than an encryption key used between the secure software application and the D & D module. As such, the secure software application can decrypt and/or de-obfuscate the data received from the O & E module using a first algorithm and can encrypt and/or obfuscate the data using a second algorithm prior to sending the data to the D & D module.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of the embodiments where appropriate. For example, in some embodiments a hardware-based O & E module can be disposed within a computing device, rather than within the secure input device.

In some embodiments, a system includes an input obfuscation module and an input encryption module coupled to the input obfuscation module and configured to define a first end of a secure channel for exchanging information with a secure application module. The system can further include an output decryption module coupled to the input encryption module and configured to define a second end of the secure channel, the secure channel having no seams between the first end of the secure channel and the second end of the secure channel. The system can further include an output deobfuscation module coupled to the output decryption module.

In some embodiments, the input obfuscation module is configured to receive and obfuscate input data. In some embodiments, the input obfuscation module and the input encryption module include a secure input driver.

In some embodiments, the input obfuscation module and the input encryption module include a secure input driver, and the secure input driver is a secure keyboard input driver.

In some embodiments, the input obfuscation module and the input encryption module include a secure input driver. In some such embodiments of the system, the secure input driver is a secure keyboard input driver disposed within a hardware device, the hardware device being disposed within a physical keyboard and comprised of at least one of a hardware component; a hardware-isolated software component; and a hardware-specific operating system driver.

In some embodiments, the input obfuscation module and the input encryption module include a secure input driver. In some such embodiments, the secure input driver is a secure keyboard input driver disposed within a hardware device, the hardware device being disposed within a detachable dongle and comprised of at least one of a hardware component; a hardware-isolated software component; and a hardware-specific operating system driver.

In some embodiments, the input obfuscation module and the input encryption module include a secure input driver, and the secure input driver is a secure mouse input driver.

In some embodiments, the input obfuscation module and the input encryption module include a secure input driver. In some such embodiments of the system, the secure input driver is a secure mouse input driver disposed within a hardware device, the hardware device being disposed within a physical mouse and comprised of at least one of a hardware component; a hardware-isolated software component; and a hardware-specific operating system driver.

In some embodiments, the input obfuscation module and the input encryption module include a secure input driver. In some such embodiments, the secure input driver is a secure mouse input driver disposed within a hardware device, the hardware device being disposed within a detachable dongle and comprised of at least one of a hardware component; a hardware-isolated software component; and a hardware-specific operating system driver.

In some embodiments, the input obfuscation module and the input encryption module include a secure input driver, and the secure input driver is a secure touch-screen input driver.

In some embodiments, the input obfuscation module and the input encryption module include a secure input driver. In some such embodiments of the system, the secure input driver is a secure touch-screen input driver disposed within a hardware device, the hardware device being disposed within a physical touch-screen and comprised of at least one of a hardware component; a hardware-isolated software component; and a hardware-specific operating system driver.

In some embodiments, the input obfuscation module and the input encryption module include a secure input driver. In some such embodiments, the secure input driver is a secure touch-screen input driver disposed within a hardware device, the hardware device being disposed within a detachable dongle and comprised of at least one of a hardware component; a hardware-isolated software component; and a hardware-specific operating system driver.

In some embodiments, the output deobfuscation module is configured to output de-obfuscated data to a display device. In some embodiments of the system, the output decryption module and the output deobfuscation module include a secure output driver.

In some embodiments, the output decryption module and the output deobfuscation module include a secure monitor or video card driver disposed within a hardware device. In some such embodiments, the hardware device is comprised of at least one of: a hardware component; a hardware-isolated software or firmware component; and a hardware-specific operating system driver.

In some embodiments, the secure application module is a secure software application that executes using at least encrypted data received from the input encryption module.

In some embodiments, the secure data channel is a first secure data channel, and the secure application module is a software application container that defines a second secure data channel for exchanging data with the output decryption module.

In some embodiments, the input obfuscation module includes a virtual keyboard rendered on a monitor.

In some embodiments, the input obfuscation module includes a virtual keyboard rendered on a monitor, a visual element of the virtual keyboard is rendered in a first position on the monitor at a first time, and the visual element is rendered in a second position on the monitor at a second time in response to a virtual key selection.

In some embodiments, the input obfuscation module includes a virtual keyboard on a monitor. A mouse pointer and/or a touch screen display can be used to select portions of the virtual keyboard. In some embodiments, a driver of the mouse and/or the touch screen display can encrypt and/or obfuscate one or more coordinates associated with a selection made by the mouse and/or the touch screen display.

In some embodiments, the output decryption module can process received information without the information having passed through the output deobfuscation module.

What is claimed is:

1. A system, comprising:
an input obfuscation module implemented in at least one of a memory or a processing device;
an input encryption module configured to be operatively coupled to the input obfuscation module and configured to define a first end of a secure channel for exchanging information with a secure application module, the input encryption module configured to receive data from the input obfuscation module;
an output decryption module configured to be operatively coupled to the secure application module and configured to define a second end of the secure channel, the secure channel having no seams between the first end of the secure channel and the second end of the secure channel, the output decryption module configured to receive data from the secure application module; and
an output de-obfuscation module configured to be operatively coupled to the output decryption module, the output de-obfuscation module configured to receive data from the output decryption module.

2. The system of claim 1, wherein the input obfuscation module is configured to receive and obfuscate input data.

3. The system of claim 1, wherein at least one of the input obfuscation module or the input encryption module includes a secure input driver.

4. The system of claim 1, wherein:
at least one of the input obfuscation module or the input encryption module includes a secure input driver; and
the secure input driver is a secure keyboard input driver configured to operate securely without operating system awareness.

5. The system of claim 1, wherein:
at least one of the input obfuscation module or the input encryption module includes a secure input driver; and
the secure input driver is a secure keyboard input driver disposed within a hardware device, the hardware device being disposed within a physical keyboard, the hardware device including hardware, hardware isolated software or firmware, and a hardware specific operating system driver.

6. The system of claim 1, wherein:
at least one of the input obfuscation module or the input encryption module includes a secure input driver; and
the secure input driver is a secure keyboard input driver disposed within a hardware device, the hardware device being disposed within a detachable dongle, the hardware device including hardware, hardware isolated software or firmware, and a hardware specific operating system driver.

7. The system of claim 1, wherein the output de-obfuscation module is configured to output de-obfuscated data to at least one of a secure monitor driver or a secure graphic card driver.

8. The system of claim 1, wherein at least one of the output decryption module or the output de-obfuscation module include a secure output driver configured to operate securely without operating system awareness.

9. The system of claim 1, wherein at least one of the output decryption module or the output de-obfuscation module include a secure output driver configured to operate securely with operating system awareness.

10. The system of claim 1, wherein at least one of the output decryption module or the output de-obfuscation module include at least one of a secure monitor driver or a secure graphic card driver.

11. The system of claim 1, wherein at least one of the output decryption module or the output de-obfuscation module include a at least one of a secure monitor or video card driver disposed within a hardware device, the hardware device including hardware, hardware isolated software or firmware, and a hardware specific operating system driver

12. The system of claim 1, wherein the secure application module is a secure software application configured to execute using at least encrypted data received from the input encryption module.

13. The system of claim 1, wherein the secure channel is a first secure channel, the secure application module is a software application container that defines a second secure channel for exchanging data with the output decryption module.

14. The system of claim 1, wherein the input obfuscation module is configured to be collocated with and receive data from at least one of a virtual keyboard rendered on a monitor, a microphone, or a biometric scanner.

15. The system of claim 1, wherein:
the input obfuscation module is configured to receive data from a virtual keyboard rendered on a monitor; and
a visual element of the virtual keyboard is rendered in a first position on the monitor at a first time, and the visual element is rendered in a second position on the monitor at a second time in response to a virtual key selection.

16. The system of claim 1, wherein:
the input obfuscation module is configured to receive at least one coordinate associated with a selection on a virtual keyboard rendered on a monitor; and
the input obfuscation module is configured to obfuscate the at least one coordinate.

17. The system of claim 1, wherein the secure application module is configured to read obfuscated data.

18. The system of claim 1, wherein the input obfuscation module is configured to receive data from at least one of a process, a machine, a module, or a software component executing in a processor.

19. A non-transitory processor-readable medium storing code representing instructions to be executed by a processor, the code comprising code to cause the processor to:
receive an input datum at an obfuscator-encryptor module physically collocated with an input device;
obfuscate, at the obfuscator-encryptor module, the input datum to define an obfuscated datum;
encrypt, at the obfuscator-encryptor module, the obfuscated datum to define an obfuscated-encrypted datum; and
send, via a seamless secure channel, the obfuscated-encrypted datum to a de-obfuscator-decryptor module collocated with an output device such that the de-obfuscator-decryptor module decrypts and de-obfuscates the obfuscated-encrypted datum to produce output datum to be presented at the output device.

20. The non-transitory processor-readable medium of claim 19, wherein the code to cause the processor to send includes code to cause the processor to send the obfuscated-encrypted datum to the de-obfuscator-decryptor module via the seamless secure channel, which includes a secure application module.

21. The non-transitory processor-readable medium of claim 19, wherein the input device is at least one of a physical keyboard, a virtual keyboard, a computer mouse, a trackpad, a trackpoint, a joystick, a microphone, or an optical camera.

22. The non-transitory processor-readable medium of claim 19, wherein the output device is a display device.

23. An apparatus, comprising:
an encryption module configured to be executed at an input device, the encryption module configured to receive an input datum from an input of the input device and encrypt the input datum to define a first encrypted datum;
a secure application module configured to receive the first encrypted datum from the encryption module, the secure application module configured to process the first encrypted datum to define a second encrypted datum; and
a decryption module configured to be executed at an output device, the decryption module configured to receive the second encrypted datum from the secure application module and decrypt the second encrypted datum to define an output datum.

24. The apparatus of claim 23, wherein the input device is at least one of a physical keyboard, a virtual keyboard, a computer mouse, a trackpad, a trackpoint, a joystick, a microphone, a biometric sensor or an optical camera.

25. The apparatus of claim 23, wherein the output device is a display device.

26. The apparatus of claim 23, wherein the encryption module is disposed within a hardware dongle device physically coupled to the input device.

27. The apparatus of claim 23, wherein the encryption module defines a first end portion of a seamless secure channel and the decryption module defines a second end portion of the seamless secure channel.

28. The apparatus of claim 23, wherein the output datum is an obfuscated output datum, the apparatus further comprising:
a de-obfuscation module configured to be executed at the output device, the de-obfuscation module configured to receive the obfuscated output datum from the decryption module and de-obfuscate the obfuscated output datum to define a de-obfuscated output datum.

29. The apparatus of claim 23, wherein the encryption module is stored within a memory protected by at least one of virtually isolated memory space or obfuscated memory space.
